(19) United States
(12) Patent Application Publication
(10) Pub. No.: US 2021/0170347 A1
(43) Pub. Date: Jun. 10, 2021

(54) TERPENE SOLUTION COMPOSITION AND METHOD OF MANUFACTURE

(71) Applicant: Synergy Research Group, Inc., North Hollywood, CA (US)

(72) Inventors: Mike Schneider, Sherman Oaks, CA (US); Adriana Mezgova, La Crescenta, CA (US)

(73) Assignee: Synergy Research Group, Inc., North Hollywood, CA (US)

(21) Appl. No.: 16/708,295

(22) Filed: Dec. 9, 2019

(51) Int. Cl. B01F 3/08; B01F 17/00

(52) U.S. Cl. CPC B01F 3/088; B01F 3/0811; C11B 9/0003; B01F 2003/0896; B01F 2003/0823; B01F 17/0028

(57) ABSTRACT

A terpene composition, adapted at least for olfactory use, has one or more terpene materials. Furthermore, the terpene composition has one or more emulsifiers. The terpene composition also has a humectant. Finally, the terpene composition has a solvent. The one or more terpene materials are in a range of five to fifty percent of the terpene composition.

### BACKGROUND

### 1. Field

This disclosure generally relates to terpenes. More particularly, the disclosure relates to terpene compositions adapted for olfactory use and/or gustatory use.

### 2. General Background

Terpenes are hydrocarbon compounds found in a variety of plants, some of which are cannabis and some of which are not. In particular, terpenes are recognized for their ability to emit a strong aroma of varying scents, depending upon the particular terpene strain. With respect to cannabis, terpenes emit such scents to deter would-be attackers, such as herbivores, from eating the plant, or attract those who are more interested in eating the attackers, such as carnivores.

Furthermore, many cannabis plant growers tend to grow cannabis in a way that strengthens the potency of tetrahydrocannabinol (“THC”), which typically has the psychoactive effect of producing a sense or euphoria in a human being, the result of THC binding with cannabinoid 1 (“CB1”) receptors in the brain. Cannabis plants with a higher potency of THC than others also tend to have the terpenes that emit a smell typically considered to be a desirable aroma to many users of cannabis.

While being grown, cannabis may lose some, if not all, of the aroma associated with its terpenes. The aroma may be lost, or diminished, based on a variety of factors (e.g., seed selection, sub-optimal growing environment, etc.).

As a result, current apparatuses and processes do not adequately maintain the natural aroma from cannabis after being grown.

### SUMMARY

A terpene composition, adapted for olfactory and/or gustatory use, has one or more terpene materials. Furthermore, the terpene composition has one or more emulsifiers. The terpene composition also has a humectant. Finally, the terpene composition has a solvent. The one or more terpene materials are in a range of five to fifty percent of the terpene composition.

Alternatively, a process for manufacture of a terpene composition, adapted for olfactory and/or gustatory use, determines an amount of one or more terpene materials that meets a predetermined weight threshold of the terpene composition. Additionally, the process adds one or more emulsifiers to the one or more terpene materials. The process also mixes the one or more terpene materials in the one or more emulsifiers, until the one more terpene materials are dissolved, to form an emulsified solution. Furthermore, the process adds a humectant to the emulsified solution. Also, the process mixes the humectant with the emulsified solution, according to a predetermined time threshold based on batch size, to form a viscous solution. In addition, the process adds a solvent to the viscous solution. Finally, the process mixes the solvent with the viscous solution to form the terpene composition. The one or more terpene materials are in a range of five to fifty percent of the terpene composition.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1A illustrates a front perspective view of the physical environment.

FIG. 1B illustrates a rear perspective view of the physical environment.

FIG. 2A illustrates the user adding one or more emulsifiers, via the one or more emulsifier flasks, to the terpene blend that was added to the beaker, as illustrated in FIG. 1.

FIG. 2B illustrates the user mixing the terpene blend with the one or more emulsifiers until the one or more emulsifiers are dissolved in the terpene blend to produce an emulsified solution.

FIG. 3A illustrates the user adding a humectant, via the glycerine flask, to the emulsified solution of FIG. 2B.

FIG. 3B illustrates the user mixing the humectant with the emulsified solution according to a predetermined time threshold, based on batch size, to form a viscous solution.

FIG. 4A illustrates the user adding the solvent to the viscous solution illustrated in FIG. 3B.

FIG. 4B illustrates the user mixing the solvent with the viscous solution to form the terpene composition.

FIG. 5 illustrates a process that may be utilized to form the terpene composition.

### DETAILED DESCRIPTION

A terpene composition is adapted for olfactory and/or gustatory use. In particular, the terpene composition may be used to infuse an aroma into a storage container that stores one or more cannabis materials (e.g., cannabis flowers, leaves, etc.), either during transportation for sale, storage prior to sale, or storage by an end-user. As a result, cannabis aroma emission is not only restored, but can also be modified into a particular aroma enhancement that is desirable to users during use, without compromising on the potency of THC.

In particular, the terpene composition may include a variety of ingredients that help ensure the foregoing aroma infusion effect. An example of the formula for the terpene composition is provided in the following table (expressed in weight percentage):

| Ingredient | Wt % |
|---|---|
| Terpene Blend | 10 |
| Polysorbate 20 | 2.5 |
| Polysorbate 80 | 2.5 |
| Glycerine | 55 |
| Deionized Water | 30 |

As an example, the terpene blend may have a weight percentage of ten percent of the entire composition. The terpene blend may include one or more terpene materials. As an example, the terpene materials may include one or more naturally derived non-cannabis terpene isolates, which are food grade. As another example, the terpene materials may include one or more terpenes extracted from one or more cannabis plants. As yet another example, the terpene materials may form a cannabis/non-cannabis hybrid formulation, including one or more naturally derived non-cannabis terpene isolates and one or more terpenes extracted from one or more cannabis plants.

Furthermore, the terpene blend may include materials other than specific terpenes. For instance, the terpene blend may include one or more essential oils. Additionally, or alternatively, the terpene blend may include one or more flavor enhancers, such as an ester and an aldehyde.

Furthermore, the terpene composition may have one or more emulsifiers, such as polysorbate 20, which may have a weight percentage of two and five tenths percent, and polysorbate 80, which may also have a weight percentage of two and five tenths percent. (Although two emulsifiers are described herein, one emulsifier or more than two emulsifiers may be used instead. Furthermore, different emulsifiers other than polysorbate 20 and polysorbate 80 may be used.)

Additionally, a humectant, such as glycerine, may be used to thicken the terpene composition—in essence providing viscosity to prevent deformation. In one embodiment, the humectant has the largest weight percentage of any of the ingredients in the terpene composition (e.g., fifty five percent). Another example of a humectant that may be used is propylene glycol. Yet another example of a humectant is butylene glycol. Alternatively, a combination of humectants (e.g., glycerine/propylene glycol/butylene glycol) may be utilized.

Finally, the terpene composition may have a solvent, such as various forms of water. For example, deionized water may have a weight percentage of thirty percent of the entire terpene composition. (Alternative forms of water (e.g., distilled water, spring water, drinking water, purified water, alkaline water, reverse osmosis water, tap water, and electrolyte-enhanced water) may be used instead of deionized water.) Alternatively, a solvent other than water may be used instead.

The specific formula provided in the table above is only one example of a particular formulation, by weight percentage, that may be used for the terpene composition. A variety of weight percentages, being bounded by certain ranges, may be used to determine other formulations. The table illustrated below provides weight percentage ranges for the various ingredients in the terpene composition:

| Ingredient | Wt % Range |
|---|---|
| Terpene Blend | 5 to 50 |
| Polysorbate 20 | 0 to 20 |
| Polysorbate 80 | 0 to 20 |
| Glycerine | 35 to 75 |
| Deionized Water | 0 to 50 |

As illustrated in the table above, the terpene blend may have a weight percentage in the range of five percent to fifty percent, leaving at least half of the remainder of the terpene composition to be other ingredients. Furthermore, the humectant (e.g., glycerine) may have a weight percentage in the range of thirty five percent to seventy five percent. In essence, the terpene blend itself, and the humectant that increases viscosity of the terpene composition to prevent deformation, are necessary ingredients in the terpene composition.

Conversely, the other ingredients may be optional. For example, the emulsifiers (e.g., polysorbate 20 and polysorbate 80) may disperse the terpene blend in an emulsion for subsequent thickening via the humectant, but the terpene blend may be exposed to the humectant without any emulsion. As another example, the terpene composition may not have any water.

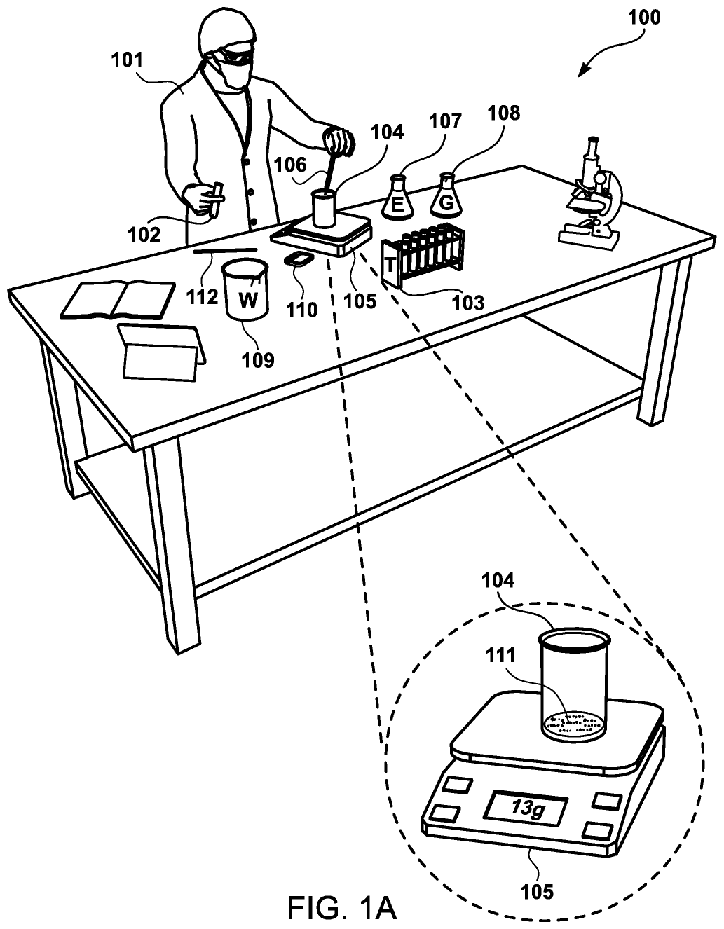

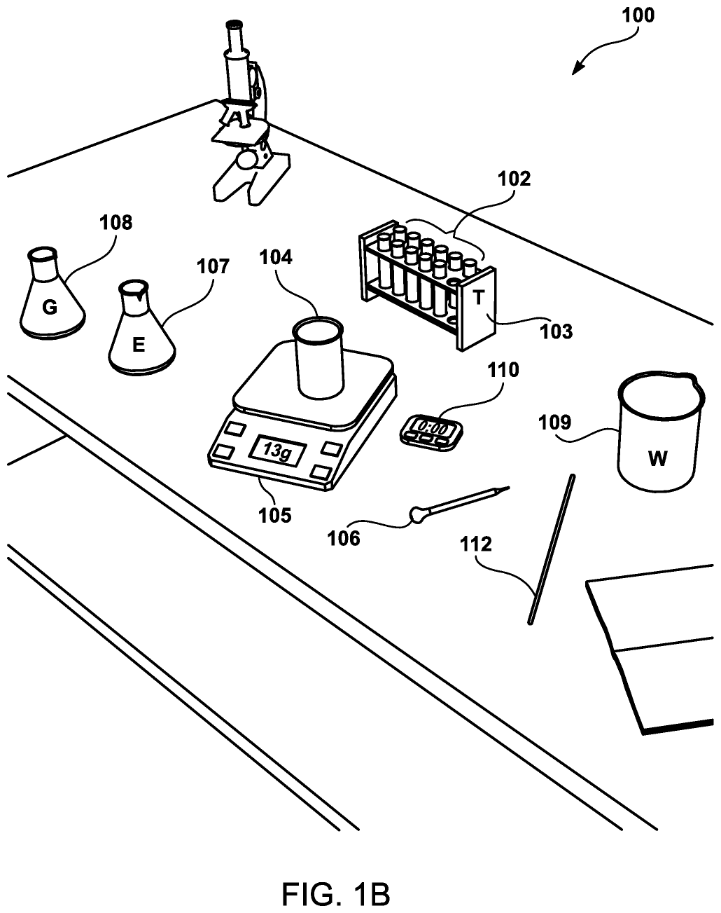

Moreover, a particular process for manufacturing the terpene composition is provided for herein. FIGS. 1A and 1B illustrate a physical environment 100 in which a user 101 (e.g., lab technician) prepares the terpene composition. In particular, FIG. 1A illustrates a front perspective view of the physical environment 100. Conversely, FIG. 1B illustrates a rear perspective view of the physical environment 100.

Initially, the user 101 procures a container 102 (e.g., vial, test tube, etc.) containing a terpene blend 111. For example, a container rack 103 may contain a plurality of containers 102, each having the same terpene blend 111 or each having different terpene blends 111. The user 101 may begin the process by weighing a beaker 104 containing the terpene blend on a scale 105, as the user 101 pours the terpene blend 111 into the beaker 104. For example, the user 101 may pour the terpene blend 111, either directly from the container 102 or indirectly from a dropper 106, into the beaker 104 until a predetermined weight has been reached.

Additionally, FIGS. 1A and 1B illustrate other equipment that will be subsequently used in the manufacturing process of the terpene composition. For example, one or more emulsifier flasks 107 may be labeled/allocated for storing one or more emulsifiers. As another example, a glycerine flask 108 may be labeled/allocated for storing glycerine, or another humectant. As another example, a solvent flask 109 may be labeled/allocated for storing a solvent, such as water. The user 101 may also use a digital timer 110 to determine time constraints during the manufacturing process. Finally, the user 101 may user a stirring rod 112 to mix various ingredients.

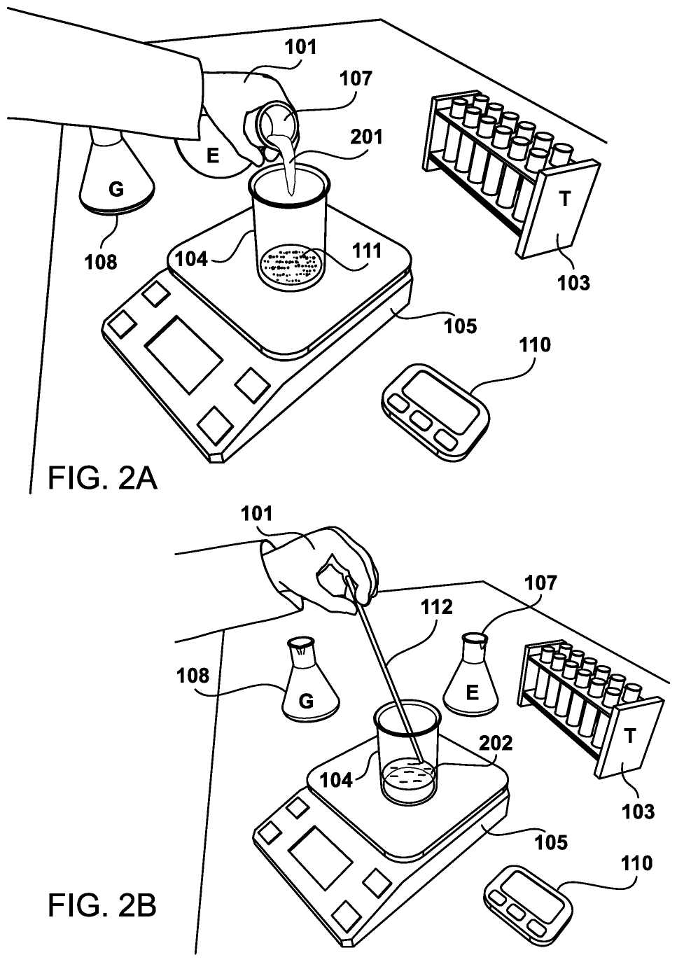

FIGS. 2A and 2B illustrate an emulsification phase of the manufacturing process for the terpene composition. In particular, FIG. 2A illustrates the user 101 adding one or more emulsifiers 201, via the one or more emulsifier flasks 107, to the terpene blend that was added to the beaker 104, as illustrated in FIG. 1. After adding the one or more emulsifiers 201 to the terpene blend 111, the user 101 may utilize the stirring rod 112 to mix, as illustrated in FIG. 2B, the terpene blend 111 with the one or more emulsifiers 201 until the one or more emulsifiers 201 are dissolved in the terpene blend 201 to produce an emulsified solution 202.

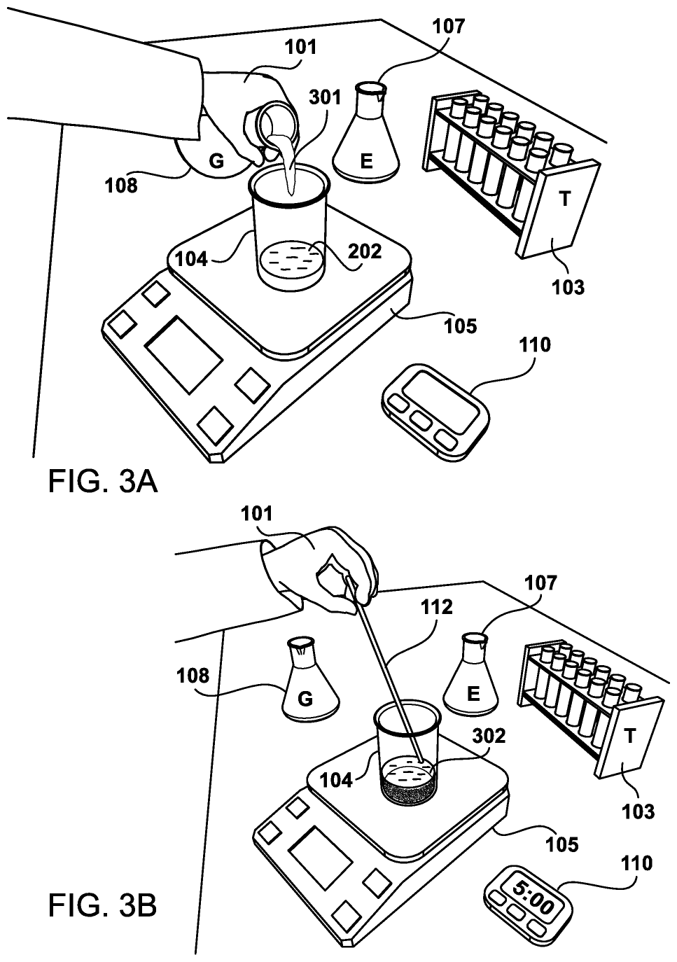

FIGS. 3A and 3B illustrate a viscosity phase of the manufacturing process for the terpene composition. In particular, FIG. 3A illustrates the user 101 adding a humectant 301 (e.g., glycerine), via the glycerine flask 108, to the emulsified solution 202 of FIG. 2B. Further, FIG. 3B illustrates the user 101 mixing, utilizing the stirring rod 112, the humectant 301 with the emulsified solution 202 according to a predetermined time threshold, based on batch size, to form a viscous solution 302. For example, the predetermined time threshold may be in the range of five to fifteen minutes; a smaller intended batch size of the terpene composition corresponding to five minutes, and a larger intended batch size of the terpene composition corresponding to fifteen minutes. (The range of five to fifteen minutes is provided only as an example, and may vary.)

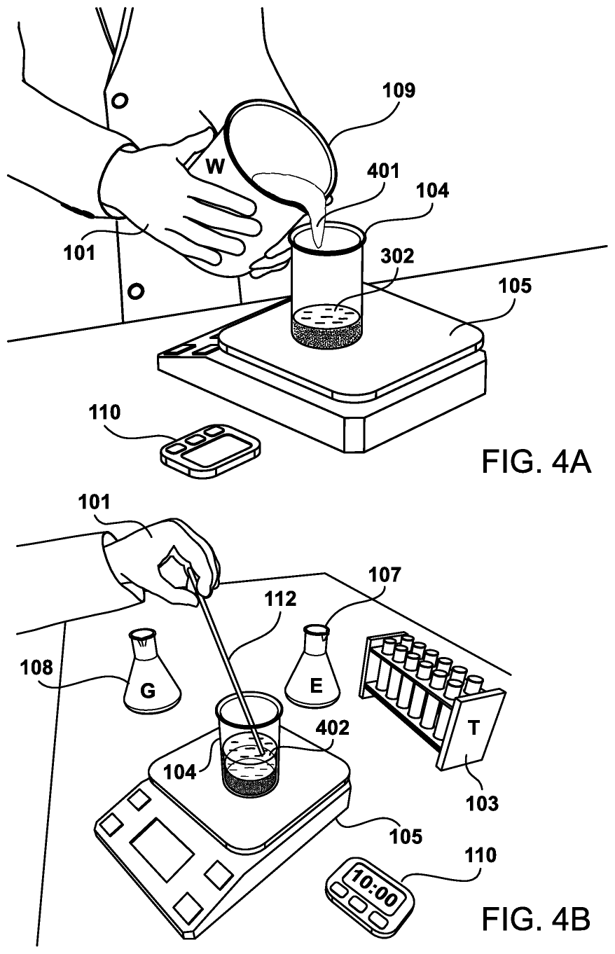

Finally, FIGS. 4A and 4B illustrate a solvent phase in which the viscous solution 302 is mixed with a solvent 401. FIG. 4A illustrates the user 101 adding the solvent 401 to the viscous solution 302 illustrated in FIG. 3B. Various solvents may be utilized. As an example, the solvent 401 may be water (e.g., deionized water, distilled water, spring water, drinking water, purified water, alkaline water, reverse osmosis water, tap water, and electrolyte-enhanced water). Additionally, FIG. 4B illustrates the user 101 mixing the solvent 401 with the viscous solution 302 to form the terpene composition 402. Initially, the terpene composition may turn opaque and white. The user 101 may mix the terpene composition 402 according to a predetermined time threshold until the terpene composition 402 is fully dissolved (i.e., no longer opaque and white). For example, the predetermined time threshold may be in the range of ten to twenty minutes.

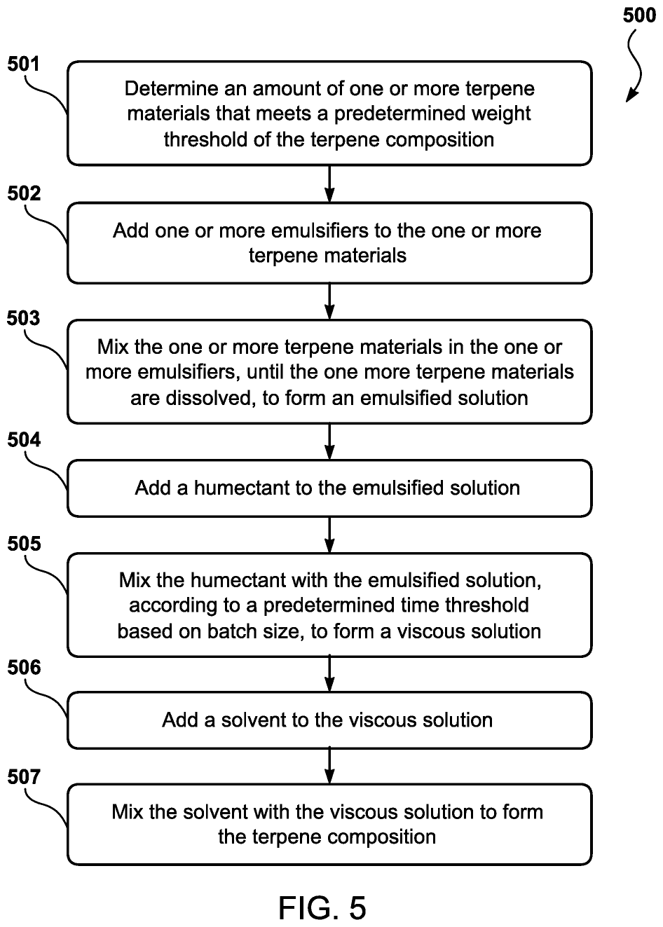

To summarize, FIG. 5 illustrates a process 500 that may be utilized to form the terpene composition 402, illustrated in FIG. 4B. At a process block 501, the process 500 determines an amount of one or more terpene materials that meets a predetermined weight threshold of the terpene composition 402. Furthermore, at a process block 502, the process 500 adds one or more emulsifiers 201 to the one or more terpene materials. Additionally, at a process block 503, the process 500 mixes the one or more terpene materials in the one or more emulsifiers 201, until the one more terpene materials are dissolved, to form an emulsified solution 202, as illustrated in FIG. 2B. At a process block 504, the process 500 adds a humectant 301 to the emulsified solution 202. Furthermore, at a process block 505, the process 500 mixes the humectant 301 with the emulsified solution 202, according to a predetermined time threshold based on batch size, to form a viscous solution 302, as illustrated in FIG. 4B. Alternatively, the mixing may be performed irrespective of batch size. At a process block 506, the process 500 adds a solvent 401 to the viscous solution 302. Further, at a process block 507, the process 500 mixes the solvent 401 with the viscous solution 302 to form the terpene solution 402. In one embodiment, the one or more terpene materials are in a range of five to fifty percent of the terpene composition 402.

Although the process 500 is illustrated in FIGS. 1A-4B as being performed by the user 101, depicted as a lab technician, the process 500, alternatively, may be performed by an end-user. As yet another alternative, the process 500 may be performed by one or more machines. Finally, as another alternative, the process 500 may be performed by a combination of the user 101 and one or more machines.

Finally, the terpene composition is just one example of an aroma restoration/enhancement composition that may be utilized with respect to cannabis. For instance, another composition may be formulated with the ingredients, and ranges provided for herein, but with one or more non-terpene materials in place of the one or more terpene materials. For example, various flavor enhancers (ester, aldehyde, etc.) may be used without any terpenes in the composition.

It is understood that the apparatuses and processes described herein may also be applied in other types of apparatuses and processes. Those skilled in the art will appreciate that the various adaptations and modifications of the embodiments of the apparatuses and processes described herein may be configured without departing from the scope and spirit of the present apparatuses and processes. Therefore, it is to be understood that, within the scope of the appended claims, the present apparatuses and processes may be practiced other than as specifically described herein.

We claim:

1. A terpene composition, adapted at least for olfactory use, comprising:
one or more terpene materials;
one or more emulsifiers;
a humectant; and
a solvent,
wherein the one or more terpene materials are in a range of five to fifty percent of the terpene composition.

2. The terpene composition of claim 1, wherein the one or more emulsifiers are in a range of one to twenty percent of the terpene composition.

3. The terpene composition of claim 1, wherein the one or more emulsifiers are selected from the group consisting of: polysorbate 20 and polysorbate 80.

4. The terpene composition of claim 1, wherein the humectant is in a range of thirty five to seventy five percent of the terpene composition.

5. The terpene composition of claim 1, wherein the humectant is glycerine.

6. The terpene composition of claim 1, wherein the humectant is propylene glycol.

7. The terpene composition of claim 1, wherein the solvent is water.

8. The terpene composition of claim 7, wherein the solvent is selected from the group consisting of: deionized water, distilled water, spring water, drinking water, purified water, alkaline water, reverse osmosis water, tap water, and electrolyte-enhanced water.

9. The terpene composition of claim 1, wherein the solvent is in a range of one to fifty percent of the terpene composition.

10. The terpene composition of claim 1, wherein the one or more terpene materials form a terpene blend of distinct terpenes extracted from one or more cannabis plants.

11. The terpene composition of claim 1, wherein the one or more terpene materials form a terpene blend comprising a plurality of naturally derived non-cannabis terpene isolates, a plurality of essential oils, and a plurality of flavor enhancers.

12. The terpene composition of claim 11, wherein the plurality of naturally derived non-cannabis terpene isolates are food grade.

13. The terpene composition of claim 11, wherein the plurality of flavor enhancers is selected from the group consisting of: an ester and an aldehyde.

14. A method of manufacture of a terpene composition, adapted at least for olfactory use, comprising:
determining an amount of one or more terpene materials that meets a predetermined weight threshold of the terpene composition;
adding one or more emulsifiers to the one or more terpene materials;
mixing the one or more terpene materials in the one or more emulsifiers, until the one more terpene materials are dissolved, to form an emulsified solution;
adding a humectant to the emulsified solution;
mixing the humectant with the emulsified solution, according to a predetermined time threshold based on batch size, to form a viscous solution;
adding a solvent to the viscous solution; and
mixing the solvent with the viscous solution to form the terpene composition,
wherein the one or more terpene materials are in a range of five to fifty percent of the terpene composition.

15. The method of claim 14, wherein the one or more emulsifiers are in a range of one to twenty percent of the terpene composition.

16. The method of claim 14, wherein the one or more emulsifiers are selected from the group consisting of: polysorbate 20 and polysorbate 80.

17. The method of claim 14, wherein the humectant is in a range of thirty five to seventy five percent of the terpene composition.

18. The method of claim 14, wherein the humectant is glycerine.

19. The method of claim 14, wherein the humectant is propylene glycol.

20. The method of claim 14, wherein the solvent is water.
